(19) United States
(12) Patent Application Publication
(10) Pub. No.: US 2020/0260650 A1
(43) Pub. Date: Aug. 20, 2020

(54) Automatic Walking Garden Trimmer

(71) Applicant: Ki Lai NG, Hong Kong (HK)

(72) Inventor: Ki Lai NG, Hong Kong (HK)

(21) Appl. No.: 16/384,943

(22) Filed: Apr. 16, 2019

(30) Foreign Application Priority Data
Feb. 20, 2019 (CN) 201910126811.9

(51) Int. Cl. A01G 3/08; A01G 3/04; A01D 34/64; A01G 23/095; B23D 45/00; B27B 5/10

(52) U.S. Cl. CPC A01G 3/088; A01G 3/04; A01D 34/64; A01G 2003/0443; B23D 45/003; B27B 5/10; A01G 23/0955

(57) ABSTRACT

The invention relates to an automatic walking garden trimmer which includes a power locomotive and a trimming device. The power locomotive is rotatably connected with a turntable support whose horizontal rotation is driven by a power device. The turntable support is hinged with a lower support arm and a base cylinder which drives the lower support arm to swing. The end of the lower support arm is hinged with at least two outstretched arms and an extension cylinder used to drive the outstretched arms to swing and adjust outstretching distance. The connecting seat is connected to a sphere. Two sets of trimming devices are arranged on the side of the sphere. The trimming device includes a spiral device and a trimming ring. The spiral device includes a spiral bracket and a sleeve arranged on the spiral bracket. The rotating blade of the trimming device of the present invention can be replaced. The operator can select a suitable blade according to the shape and size of the trimmed shoots, and operate the device to make the device have a wider use range with practicality. In the case of a damaged blade, a new blade can be replaced, saving maintenance time and enhancing work efficiency.

### FIELD OF THE INVENTION

The invention relates to the field of garden machinery and equipment, in particular to an automatic walking garden trimmer.

### BACKGROUND

At present, there are green belts on both sides of urban roads or highways, such as green groves planted on both sides of the road and small green trees of various shapes, and green trees planted in the isolation belts in the middle of the highway, and green trees placed on both sides of the high speed road. The trimming of most landscaping belts is done manually by ordinary hand-held trimmers, which is labor intensive and labor inefficient. Due to the inherent weight of the trimmer itself, when the green belts at high place and both sides are trimmed, it is not easy to complete the trimming with a large working intensity. Such operation for a long time is easy to cause poor efficiency, and it is easy to cause physical fatigue. In addition, the green trees in the middle or both sides of the highway are not easy to be trimmed. People need to climb when trimming due to the height. Therefore, it is not only labor inefficient but also has certain potential risk in safety.

In addition, the existing trimming machine has low mechanical efficiency, single trimming style, and cannot meet the garden trimming requirements. The operation is not simple and it is time-consuming and laborious. The efficiency is low. In addition, the trimming device is driven by the motor during use and so the trimming is unstable and the shape of trimming is not beautiful. The existing device has fixed blades which is irreplaceable, so that only one type of tree or flower type can be trimmed. So the effect of trimming is single. The thickness and hardness of different trees are different, so the blades are seriously damaged. In view of the shortcomings in the prior art, it is necessary to provide a novel device.

### SUMMARY OF THE INVENTION

The present invention provides an automatic walking garden trimmer capable of automatically trimming the green belts on both sides of the road with high efficiency, which solves the technical problem regarding low efficiency, high labor intensity, single trimming style, and unattractive shape, etc. of the existing trimming devices.

An automatic walking garden trimmer includes a power locomotive, a trimming device and a controller. The power locomotive is rotatably connected with a turntable support whose horizontal rotation is driven by a power device. The turntable support is hinged with a lower support arm and a base cylinder which drives the lower support arm to swing. The end of the lower support arm is hinged with at least two outstretched arms and an extension cylinder used to drive the outstretched arms to swing and adjust outstretching distance. The end of the outstretched arms is rotatably connected to a connecting seat and a rotary power device used to drive the connecting seat to rotate. The plane formed by the rotating track of the connecting seat is parallel or coincident with the plane formed by the swinging track of the outstretched arms. The connecting seat is connected to a sphere.

Two sets of trimming devices are arranged on the side of the sphere. The trimming device includes a spiral device and a trimming ring. The spiral device includes a spiral bracket and a sleeve arranged on the spiral bracket. The lengths of the sleeves of the two sets of trimming devices are different. The sleeve is provided with two rows of first telescopic rods, second telescopic rods and third telescopic rods from the inside to the outside through the hydraulic cylinder. The outer end of the third telescopic rod is provided with a push rod, and the outer end of the push rod is provided with a tension spring with strong hardness. The outer end of the tension spring is provided with a hook. The trimming ring includes a plurality of metal skeletons. Pin mounting holes are arranged at both ends and the midpoint position of each metal skeleton. The pin mounting holes in the middle of every two metal skeletons coincide, and are mounted as an “X” type cross movable member through the pins. The ends of opposite sides of every two “X” type cross movable members are connected by pins. A plurality of “X” type cross movable members are connected to form an annular telescopic trimming ring. Two hooks are fixedly connected to the two metal skeletons of one of the “X” cross movable members on the trimming ring.

A micro motor is mounted under the connecting pin of each of the two “X” type cross movable members in the trimming ring, and a detachable rotating blade is mounted on the output shaft of the micro motor.

The power device, the base cylinder, the micro motor, the extension cylinder, and the rotary power device are all controlled by the controller.

Preferably, the radius of the trimming ring when in the fully extended state is three times that when it is in the fully contracted state.

In a more preferred embodiment, the maximum length of the rotating blade is no more than ½ of the length of the metal skeleton.

In a more preferred embodiment, each of the two sets of trimming devices is disposed between 110 and 180 degrees from the axis in the middle of the sphere.

In a more preferred embodiment, the rear end of the extension cylinder and the end of a piston rod are respectively hinged to the front of a front outstretched arm and the middle front of a rear outstretched arm among two adjacent outstretched arms.

In a more preferred embodiment, the connecting seat is rotatably connected to a rotating shaft of the overhanging end of the outstretched arm. The rotary power device includes a rotary shifting gear coupled to the outstretched arm and dynamically connected to a servo driving motor. A worm segment is disposed on the power output end of the rotary shifting gear. The rotary shaft is provided with a power worm gear that meshes with the worm segment.

In a more preferred embodiment, the rotary power device includes a connecting rod fixed to the connecting seat, and the connecting rod and the extended end of the outstretched arm are hinged by a hinge shaft. The outstretched arm is hinged with a pulling cylinder. The piston rod of the puling cylinder is hinged to the connecting seat.

In a more preferred embodiment, the turntable support is rotatably coupled to a main shaft of rear support seat of the power locomotive. The power device includes a main shifting gear connected to the rear support seat and driven by a main driving motor. A worm segment is disposed on the power output shaft of the main shifting gear. The main shaft is provided with a worm gear that meshes with the worm segment.

In a more preferred embodiment, the rear support base is provided with a brake plate that is driven by the electric push rod and can abut against the turntable support. The electric push rod and the main driving motor are controlled by the controller.

In a more preferred embodiment, the controller is automatically controlled using a PLC controller.

Compared to the prior art, the technical effect of the present invention is as follows.

The rotating blade of the trimming device of the present invention can be replaced. The operator can select a suitable blade according to the shape and size of the trimmed shoots, and operate the device to make the device have a wider use range with practicality. In the case of a damaged blade, a new blade can be replaced, saving maintenance time and enhancing work efficiency.

The invention has two sets of trimming devices, and the stability is high. The trimming device includes a spiral bracket. In addition, the spiral bracket greatly reduces the vibration during the operation, thereby making the device more stable. The first telescopic rod, the second telescopic rod, the third telescopic rod, the push rod and the tension spring are arranged, to greatly improve the expansion ratio. The lengths of the sleeves are different. Different sleeves can be selected in accordance with the heights of different branches by adjusting the rotating shaft. Different rotating blades are replaced according to the thickness of different branches to better achieve the trimming of the branches.

The invention can automatically trim green plants on both sides of the urban road or on both sides of the highway through the above-mentioned mechanism, and has the advantages of high labor efficiency and large trimming range.

### BRIEF DESCRIPTION OF THE DRAWINGS

The invention is illustrated by the following figures and embodiments.

FIG. 1 shows a schematic diagram of the present invention in accordance with an example embodiment.

FIG. 2 shows a schematic diagram of part B in FIG. 1 in accordance with an example embodiment of the present invention.

FIG. 3 shows a schematic cross-sectional view taken along line D-D of FIG. 2.

FIG. 4 shows a schematic diagram of an example of FIG. 1 during use.

FIG. 5 shows a schematic diagram of another example of the present invention.

FIG. 6 shows a schematic diagram of a trimming ring in a contracted state in accordance with an example embodiment.

FIG. 7 shows a schematic diagram of a trimming ring in an extended state in accordance with an example embodiment.

FIG. 8 shows a schematic diagram of a trimming ring in accordance with an example embodiment.

FIG. 9 shows a rotating blade with different shapes in accordance with an example embodiment.

FIG. 10 shows a state diagram of inner extension of a sleeve in accordance with an example embodiment.

FIG. 11 shows a state diagram of inner contraction of a sleeve in accordance with an example embodiment.

FIG. 12 shows an enlarged view of the trimming device of the “C” portion of FIG. 1.

The reference numbers of the figures are as follows:
1: power locomotive; 2: turntable support; 3: lower support arm; 4: base cylinder; 5: outstretched arm; 6: extension cylinder; 7: connecting seat; 8: connecting rod; 9: pulling cylinder; 10: main driving motor; 11: main shifting gear; 12: brake plate; 17: power output shaft; 18: trimming device; 19: sphere; 20: spiral device; 21: spiral bracket; 22: sleeve; 23: first telescopic rod; 24: second telescopic rod; 25: third telescopic rod; 26: push rod; 27: tension spring; 28: hook; 29: trimming ring; 30: metal skeleton; 31: pin; 32: micro motor; 33: rotating blade; 34: electric push rod.

### DETAILED DESCRIPTION

The invention is illustrated in accordance with figures. The figures as simplified diagrams demonstrate the basic structures of the apparatus of embodiments of the invention. Thus, the invention is not limited to the figures.

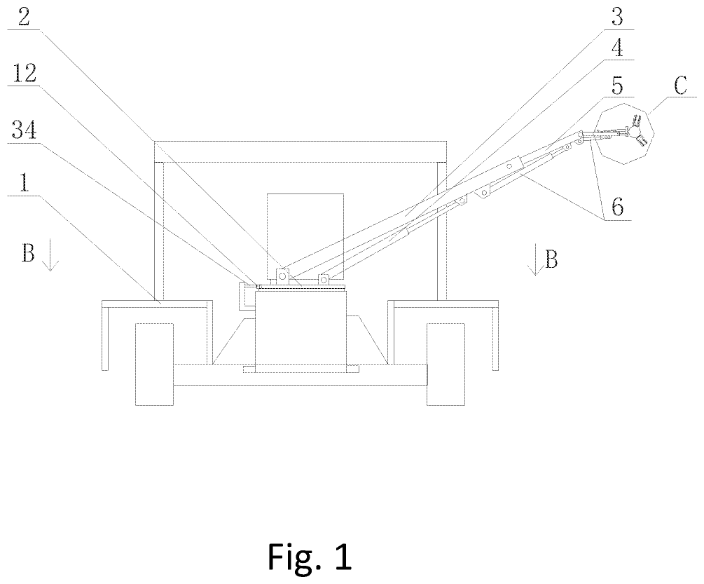

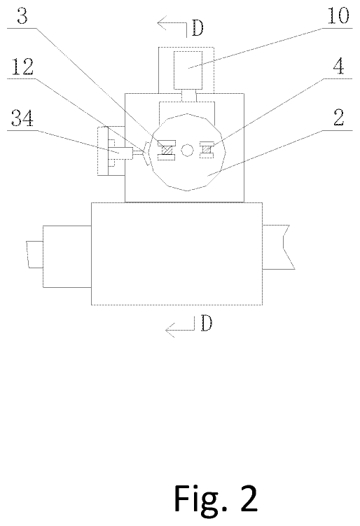

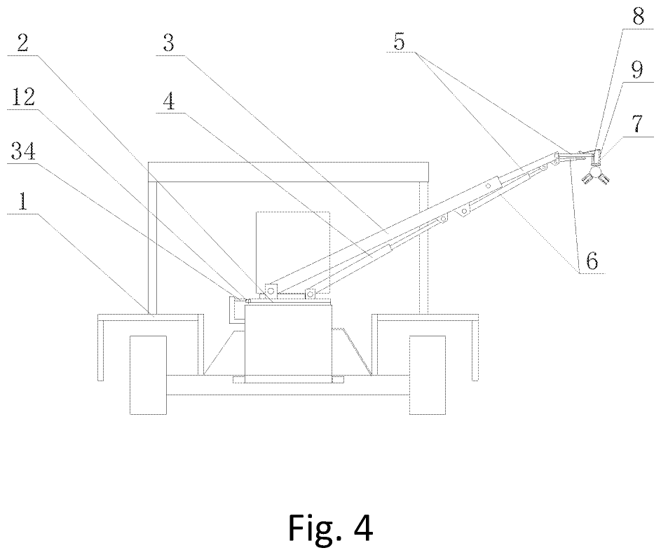

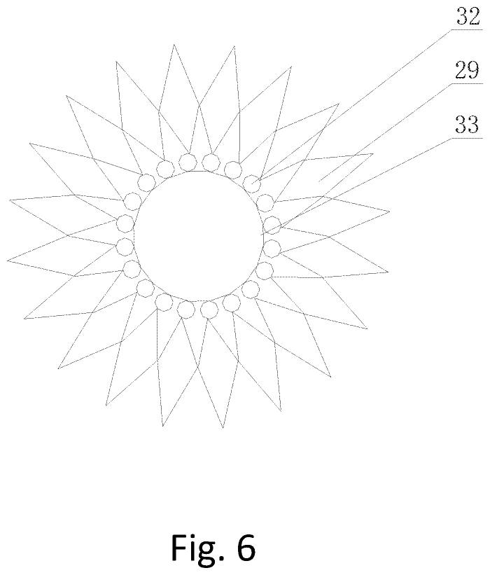

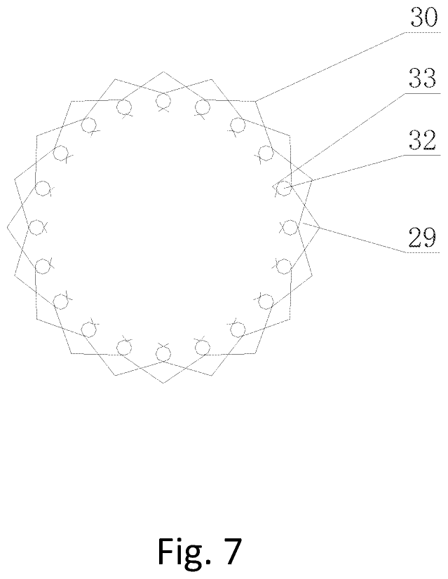

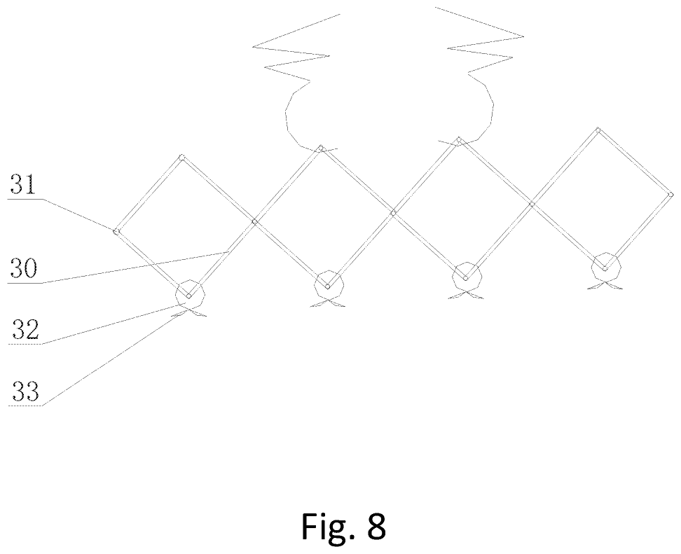

Referring to FIGS. 1-12, an automatic walking garden trimmer includes a power locomotive 1. The power locomotive 1 can be a tractor or other locomotive. The traveling mechanism, the power mechanism and the control mechanism are all prior art, and will not be described herein. The power locomotive 1 is rotatably connected with a turntable support 2 whose horizontal rotation is driven by a power device. The turntable support 2 is hinged with a lower support arm 3 and a base cylinder 4 which drives the lower support arm 3 to swing. The end of the lower support arm 3 is hinged with at least two outstretched arms 5 and an extension cylinder 6 used to drive the outstretched arms to swing and adjust outstretching distance. In one example embodiment, two outstretched arms 5, the rear end of the extension cylinder 6, and the end of piston rod hinged to the end of the outstretched arms 3 are respectively hinged to the front of the front outstretched arm 5 and the middle front portion of the rear outstretched arm 5 among two adjacent outstretched arms. The front and the rear refer to the position relative to the power locomotive. The lower support arm 3 and the two outstretched arms 5 are all placed in the same plane. Therefore, the overhanging end of the outstretched arm 5 can be expanded outward by the power driving of the base cylinder 4 and the extension cylinder 6. The end of the outstretched arm 5 is rotatably coupled to the connecting seat 7 and a rotary power device for driving the rotation of the connecting seat 7. The plane formed by the rotating track of the connecting seat 7 is parallel or coincident with the plane formed by the swinging track of the outstretched arms 5. The connecting seat 7 is connected to a sphere 19.

Two sets of trimming devices 18 are arranged on the side of the sphere 19. Each of the two sets of trimming devices 18 is disposed between 110 and 180 degrees from the axis in the middle of the sphere. The trimming device 18 includes a spiral device 20 and a trimming ring 29. The spiral device 20 includes a spiral bracket 21 and a sleeve 22 arranged on the spiral bracket 21. The lengths of the sleeves 22 of the two sets of trimming devices 18 are different. The sleeve 22 is provided with two rows of first telescopic rods 23, second telescopic rods 24 and third telescopic rods 25 from the inside to the outside through the hydraulic cylinder. The outer end of the third telescopic rod 25 is provided with a push rod 26, and the outer end of the push rod 26 is provided with a tension spring 27 with strong hardness. The outer end of the tension spring 27 is provided with a hook 28. The trimming ring 29 includes a plurality of metal skeletons 30. The radius of the trimming ring 29 when it is fully extended is three times that when it is fully contracted. Pin mounting holes are arranged at both ends and the midpoint position of each metal skeleton 30. The pin mounting holes in the middle of every two metal skeletons 30 coincide, and are mounted as an “X” type cross movable member through the pins 31. The ends of opposite sides of every two “X” type cross movable members are connected by pins 31. A plurality of “X” type cross movable members are connected to form an annular telescopic trimming ring 29. Two hooks 28 are fixedly connected to the two metal skeletons 30 of one of the “X” cross movable members on the trimming ring 29. A micro motor 32 is mounted under the connecting pin of each of the two “X” type cross movable members in the trimming ring 29, and a detachable rotating blade 33 is mounted on the output shaft of the micro motor 32. The maximum length of the rotating blade 33 is not more than ½ of the length of the metal skeleton 30.

The power device, the base cylinder 4, the micro motor 32, the extension cylinder 6, and the rotary power device are all controlled by the controller. In one example embodiment, the PLC controller is used for automatic control, and the specific control structure can be obtained according to the action process, which is a prior art and will not be described here.

Preferably, the connecting seat 7 is rotatably connected to a rotating shaft of the overhanging end of the outstretched arm 5. The rotary power device includes a rotary shifting gear coupled to the outstretched arm 5 and dynamically connected to a servo driving motor. A worm segment is disposed on the power output end of the rotary shifting gear. The rotary shaft is provided with a power worm gear that meshes with the worm segment.

Preferably, the rotary power device includes a connecting rod 8 fixed to the connecting seat 7, and the connecting rod and the extended end of the outstretched arm 5 are hinged by a hinge shaft. The outstretched arm 5 is hinged with a pulling cylinder 9. The piston rod of the puling cylinder 9 is hinged to the connecting seat 7.

Preferably, the turntable support 2 is rotatably coupled to a main shaft of rear support seat of the power locomotive. The power device includes a main shifting gear 11 connected to the rear support seat and driven by a main driving motor 10. A worm segment is disposed on the power output shaft of the main shifting gear. The main shaft is provided with a worm gear that meshes with the worm segment.

Preferably, the rear support base is provided with a brake plate 12 that is driven by the electric push rod 34 and can abut against the turntable support 2. The electric push rod 34 and the main driving motor 10 are controlled by the controller.

In an example embodiment as shown in FIG. 1, the rotary power device includes a connecting rod 8 fixed to the connecting seat 7, and the connecting rod 8 and the extended end of the outstretched arm 5 are hinged by a hinge shaft. The outstretched arm 5 is hinged with a pulling cylinder 9. The piston rod of the puling cylinder 9 is hinged to the connecting seat. The connecting seat can rotate to a certain angle by the actin of the pulling cylinder 9. In other words, automatic cutting device is driven to rotate to adjust the angle of cutting.

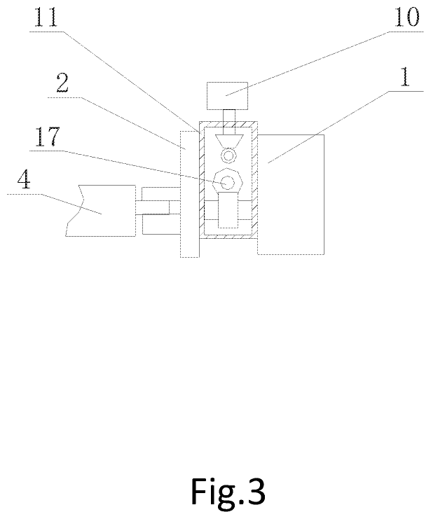

As shown in FIGS. 1, 2 and 3, the turntable support 2 is rotatably coupled to a main shaft of rear support seat of the power locomotive 1. The power device includes a main shifting gear 11 connected to the rear support seat and driven by a main driving motor 17. A worm segment is disposed on the power output shaft of the main shifting gear 11. The main shaft is provided with a worm gear that meshes with the worm segment. The structure of the main shifting gear 11 is shown in FIG. 3. The power input shaft of the main driving motor 10 is input to the main shifting gear. It is transmitted to the power output shaft 17 through a bevel gear, a middle transmission shaft and a cylinder gear. The worm segment is disposed on the power output shaft 17. Of course, the main shifting gear 11 can be other structures, which are not exemplified herein. The above structure fully utilizes the self-locking performance of the worm segment and the worm gear to ensure the rotational stability of the turntable support. The rear support seat is provided with the brake plate 12 driven by the electric push rod 34 and abuts against the turntable support 2. The electric push rod and the main driving motor 10 are controlled by a PLC controller. When the main driving motor 17 drives the turntable support 2 to rotate, the brake plate 12 is disengaged from the turntable support under the driving of the electric push rod 34. When the turntable support is stopped, the electric push rod 34 drives the brake plate 12 to abut against the turntable support 2, thereby reducing the rotational inertia of the turntable support 2, and ensuring its rotation accuracy and protection of the power driving mechanism.

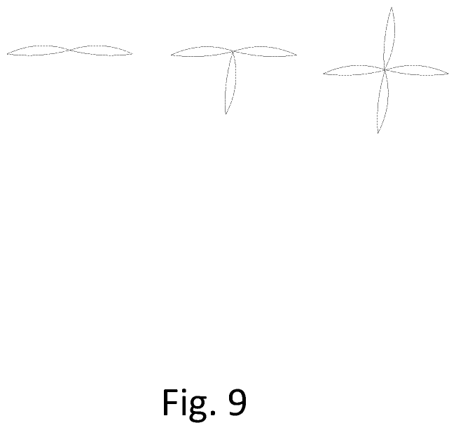

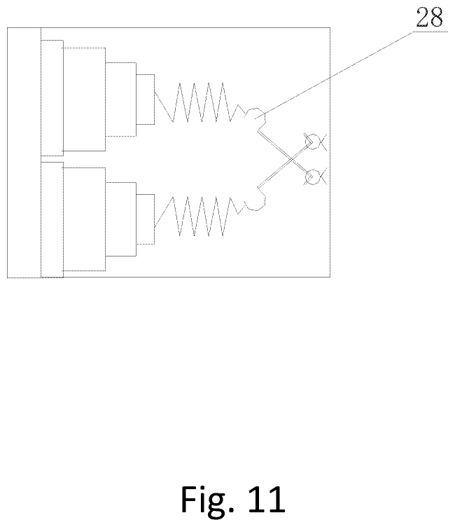

As shown in FIGS. 1 and 11, when it is necessary to trim the green plants on one side of the urban road, the power locomotive 1 travels to the roadside of the urban road. The outer end of the outstretched arm 5 can extended outwardly by the driving of the base cylinder 4 and the extension cylinder 6, which makes it be locate above the green plants or to the side of the green plants. The connecting seat 7 is rotated to a certain angle by the driving of the pulling cylinder 9, which makes a cutting fixed knife and a cutting movable knife be at an optimal cutting angle. The green plants are trimmed by the traveling of the power locomotive 1. The trimming device 18 includes a spiral device 20 and a trimming ring 29. The spiral device 20 includes a spiral bracket 21, and the spiral bracket 21 is provided with two sets of sleeves 22. The sleeves 22 of the two sets of trimming devices 18 are different. When it is necessary to trim the branches at a high position, the branch corresponding to the long sleeve is trimmed by rotating the sphere, and vice versa. When the trimming ring 29 reaches the working position, the PLC controller performs automatic control and the “X” type cross movable member is opened up. When the thick branches need to be trimmed, the PLC controller performs automatic control to realize the stretching of the trimming ring 29 and expand the trimming radius. When trimming the thin branches, the contraction of the trimming ring 29 is achieved, and the trimming radius thereof is contracted. After the trimming ring 29 is extended or contracted into position, the micro motor is controlled to drive the rotating blade 33. At the same time, different shapes of rotating blades 33 are replaced in accordance with the different shapes of branches to be trimmed, as shown in FIG. 9.

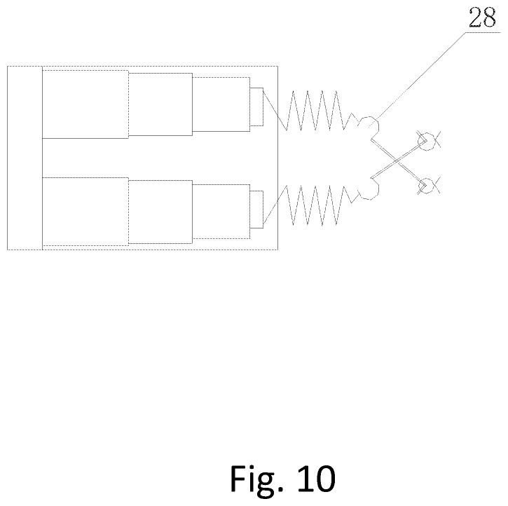

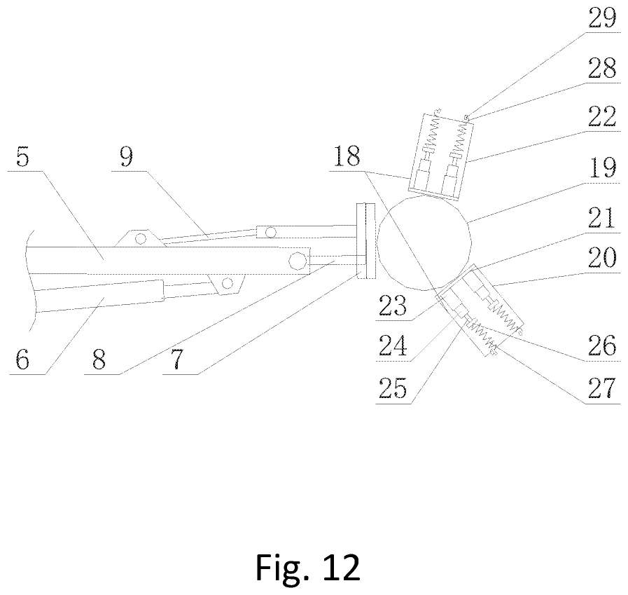

As shown in FIGS. 10 and 12, the contraction and the extension of the hydraulic cylinder is controlled by the PLC controller, thereby controlling the extension and contraction of the first telescopic rod 23, the second telescopic rod 24, and the third telescopic rod 25, and thereby controlling the contraction and extension of the tension spring 27 and the trimming ring 29. When it is necessary to trim the branches, it stretches out. When it is not necessary to trim the branches, it is contracted. It can not only save the occupied area, but also would not accidentally injure other people. It is safe and has no hidden dangers.

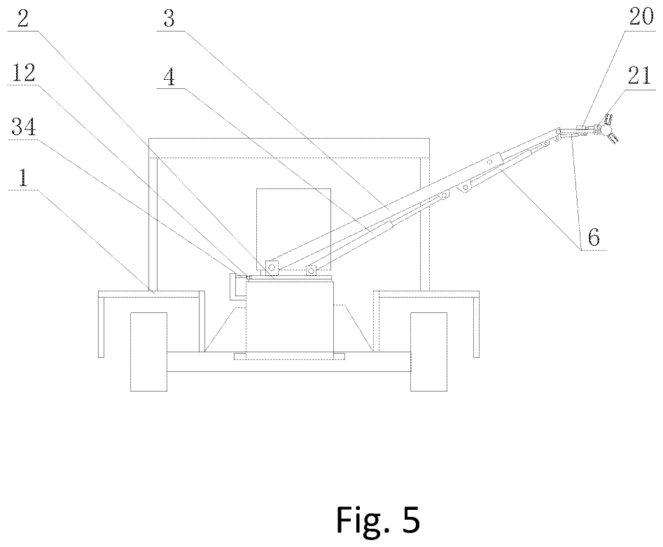

As shown in FIG. 5, the present invention provides another example embodiment which has similar basic structures as the above with the following difference. The connecting base 7 is rotatably coupled to the rotating shaft of the overhanging end of the outstretched arm 5. The rotary power device includes a rotary shifting gear coupled to the outstretched arm 5 and dynamically connected to the servo driving motor. The power output shaft of the rotary shifting gear is provided with a worm segment. The rotating shaft is provided with a power worm gear that meshes with the worm segment. The above structure is not described in detail in the drawings. Specifically, a power transmission structure similar to that of the main shifting gear in the first embodiment described above may be used, and no longer described in detail here.

The rotating blade of the trimming device of the present invention can be replaced. The operator can select a suitable blade according to the shape and size of the trimmed shoots, and operate the device to make the device have a wider use range with practicality. In the case of a damaged blade, a new blade can be replaced, saving maintenance time and enhancing work efficiency.

The invention has two sets of trimming devices, and the stability is high. The trimming device 8 includes a spiral bracket 21. In addition, the spiral bracket 21 greatly reduces the vibration during the operation, thereby making the device more stable. The first telescopic rod 23, the second telescopic rod 24, the third telescopic rod 25, the push rod 26 the tension spring 27 are arranged, to greatly improve the expansion ratio. The lengths of the sleeves 22 are different. Different sleeves 22 can be selected in accordance with the heights of different branches by adjusting the rotating shaft. Different rotating blades are replaced according to the thickness of different branches to better achieve the trimming of the branches.

The invention can automatically trim green plants on both sides of the urban road or on both sides of the highway through the above-mentioned mechanism, and has the advantages of high labor efficiency and large trimming range.

In the description of the present invention, it is to be understood that the terms “one end”, “front upper”, “end”, “length”, “width”, “inside”, “upper”, “other end”, “two ends”, “horizontal”, “coaxial”, “bottom”, “lower”, etc. are the orientation or positional relationship based on the figures, which is only for the convenience of describing the present invention and simplifying the description. It is not intended or implied that the device or component that is referred to has a particular orientation, or constructed and operated in a particular orientation, and thus is not to be construed as limiting the invention.

In the present invention, the terms “provided”, “engaged”, “connected”, “embedded”, “hood” and the like shall be understood broadly, and may be, for example, a fixed connection, unless expressly stated and limited otherwise. It can also be a detachable connection, or integrated. It can be a mechanical connection or an electrical connection. It can be directly connected or indirectly connected through an intermediate medium, which can be the internal connection of two elements or the interaction of two elements, unless otherwise expressly defined. For those skilled in the art, the specific meanings of the above terms in the present invention can be understood on a case-by-case basis.

The exemplary embodiments of the present invention are thus fully described. Although the description referred to particular embodiments, it will be clear to one skilled in the art that the present invention may be practiced with variations of these specific details. Hence this invention should not be construed as limited to the embodiments set forth herein.

What is claimed is:

1. An automatic walking garden trimmer, comprising: a power locomotive 1, a trimming device and a controller, wherein the power locomotive 1 is rotatably connected with a turntable support 2 whose horizontal rotation is driven by a power device; the turntable support 2 is hinged with a lower support arm 3 and a base cylinder 4 which drives the lower support arm 3 to swing; the end of the lower support arm 3 is hinged with at least two outstretched arms 5 and an extension cylinder 6 used to drive the outstretched arms to swing and adjust outstretching distance; the end of the outstretched arm 5 is rotatably coupled to the connecting seat 7 and a rotary power device for driving the rotation of the connecting seat 7; the plane formed by the rotating track of the connecting seat 7 is parallel or coincident with the plane formed by the swinging track of the outstretched arms 5; the connecting seat 7 is connected to a sphere 19,
wherein two sets of trimming devices 18 are arranged on the side of the sphere 19; the trimming device 18 includes a spiral device 20 and a trimming ring 29; the spiral device 20 includes a spiral bracket 21 and a sleeve 22 arranged on the spiral bracket 21; the sleeve 22 is provided with two rows of first telescopic rods 23, second telescopic rods 24 and third telescopic rods 25 from the inside to the outside through the hydraulic cylinder; the outer end of the third telescopic rod 25 is provided with a push rod 26, and the outer end of the push rod 26 is provided with a tension spring 27 with strong hardness; the outer end of the tension spring 27 is provided with a hook 28; the trimming ring 29 includes a plurality of metal skeletons 30; pin mounting holes are arranged at both ends and the midpoint position of each metal skeleton 30; the pin mounting holes in the middle of every two metal skeletons 30 coincide, and are mounted as an “X” type cross movable member through the pins 31; the ends of opposite sides of every two “X” type cross movable members are connected by pins 31; a plurality of “X” type cross movable members are connected to form an annular telescopic trimming ring 29; two hooks 28 are fixedly connected to the two metal skeletons 30 of one of the “X” cross movable members on the trimming ring 29,
wherein a micro motor 32 is mounted under the connecting pin of each of the two “X” type cross movable members in the trimming ring 29, and a detachable rotating blade 33 is mounted on the output shaft of the micro motor 32,
wherein the power device, the base cylinder 4, the micro motor 32, the extension cylinder 6, and the rotary power device are all controlled by the controller.

2. The automatic walking garden trimmer of claim 1, wherein the radius of the trimming ring 29 when in the fully extended state is three times that when it is in the fully contracted state.

3. The automatic walking garden trimmer of claim 1, wherein the maximum length of the rotating blade 33 is no more than ½ of the length of the metal skeleton 30.

4. The automatic walking garden trimmer of claim 1, wherein each of the two sets of trimming devices 18 is disposed between 110 and 180 degrees from the axis in the middle of the sphere 19.

5. The automatic walking garden trimmer of claim 1, wherein the rear end of the extension cylinder 6 and the end of a piston rod are respectively hinged to the front of a front outstretched arm 5 and the middle front of a rear outstretched arm 5 among two adjacent outstretched arms 5.

6. The automatic walking garden trimmer of claim 1, wherein the connecting seat 7 is rotatably connected to a rotating shaft of the overhanging end of the outstretched arm 5; the rotary power device includes a rotary shifting gear coupled to the outstretched arm 5 and dynamically connected to a servo driving motor; a worm segment is disposed on the power output end of the rotary shifting gear; the rotary shaft is provided with a power worm gear that meshes with the worm segment.

7. The automatic walking garden trimmer of claim 1, wherein the rotary power device includes a connecting rod 8 fixed to the connecting seat 7, and the connecting rod 8 and the extended end of the outstretched arm 5 are hinged by a hinge shaft; the outstretched arm 5 is hinged with a pulling cylinder; the piston rod of the puling cylinder is hinged to the connecting seat 7.

8. The automatic walking garden trimmer of claim 1, wherein the turntable support 2 is rotatably coupled to a main shaft of rear support seat of the power locomotive; the power device includes a main shifting gear 11 connected to the rear support seat and driven by a main driving motor 10; a worm segment is disposed on the power output shaft 17 of the main shifting gear 11; the main shaft is provided with a worm gear that meshes with the worm segment.

9. The automatic walking garden trimmer of claim 1, wherein the rear support base is provided with a brake plate 12 that is driven by the electric push rod and can abut against the turntable support 2; the electric push rod 34 and the main driving motor 10 are controlled by the controller.

10. The automatic walking garden trimmer of claim 1, wherein the controller is automatically controlled using a PLC controller.
